(19) United States
(12) Patent Application Publication
(10) Pub. No.: US 2007/0289547 A1
(43) Pub. Date: Dec. 20, 2007

(54) Portable, retractable controlling barrier for animals

(76) Inventors: Mary Haugh, Listowel (CA); Peter Jones, Guelph (CA)

Correspondence Address: MILLER THOMSON LLP, 100 STONE ROAD WEST, SUITE 301, GUELPH, ON, N1G-5L3, US

(21) Appl. No.: 11/808,629

(22) Filed: Jun. 12, 2007

Related U.S. Application Data
(60) Provisional application No. 60/813,350, filed on Jun. 14, 2006.

(51) Int. Cl. A01K 29/00; A01K 3/00

(52) U.S. Cl. 119/510

(57) ABSTRACT

A portable retractable controlling barrier for animals includes a biased retractable support assembly and an animal sensitive barrier member releasably mounted to the biased retractable support assembly wherein the animal sensitive barrier member is extendible and retractable. The portable tractable controlling barrier therefore is biased to the retracted position and therefore extends under tension to the desired length and then is biased back towards the retracted position.

### FIELD OF THE INVENTION

This invention relates in general to a gate or animal control device and more particularly to a portable retractable controlling barrier for animals.

### BACKGROUND OF THE INVENTION

Livestock management often requires moving livestock between various enclosures, sorting livestock for breeding and transportation, and actually moving the animals onto the transport vehicles. As such these moves often require skill, timing and often increased manpower to ensure that the livestock is moved in a timely, efficient and safe manner. In general when moving livestock, the livestock are often stressed, which adds increased tension to the situation for the workers involved moving the animals. In general the task of moving livestock involved some sort of handheld barrier that was positioned in front of the worker and used to guide the animals in the desired direction and act as a barrier to prevent the animals moving in an undesired direction. Depending on the livestock being herded this task could be very arduous as animals such as pigs do not respond well to handheld barriers. Furthermore the barriers were often made of a heavy material which exhausted the worker from having to carry the barrier during the entire sorting or transporting session.

Animal control devices have been devised to address the noted problems. For example, U.S. Pat. No. 6,279,512 issued on Aug. 28, 2001 to Lane. This patent relates to a method and apparatus for sorting livestock such as hogs, sheep, cows, and poultry within an enclosure and guiding the livestock to an exit opening therein is disclosed. The present invention includes an elongated, foldable livestock barrier constructed of a durable plastic material which may be attached to a perimeter wall of a livestock enclosure adjacent an exit opening therein and gradually unfolded and extended to a remote position along an opposite wall of the enclosure to separate the livestock into groups to be sorted. Thereafter, the flexible barrier is gradually refolded to shorten its effective length and moved along the perimeter wall toward the exit opening of the enclosure to gradually reduce the confined area wherein the animals to be sorted are contained.

U.S. Pat. No. 1,182,018 issued on May 9, 1916 to Koening. This patent relates to stock and poultry catchers, and aims to provide a novel and improved device of that character which will enable stock and poultry to be caught and confined within a relatively small captivity space. This invention has for its object, the provision of a stock and poultry catcher applicable to a fence, barn and other similar support, and adapted to be manipulated for catching and confining poultry.

Goossen is the owner of U.S. Pat. No. 4,006,714 which issued on Feb. 8, 1977. This patent relates to a training and crowd gate for urging animals to move through a passageway. The training and crowd gate includes an overhead track which extends along the passageway and a carriage movably suspended from the track. A cross arm is mounted on the carriage and a plurality of flexible electrical conductors hang downwardly from spaced points on the cross arm to form a barrier across the passageway. An audible signal, a conductor charger and a carriage drive unit are carried on the carriage. A control at an operator's station remote from the crowd gate simultaneously energizes the audible signal means and carriage drive unit and further connects the conductor charger to a source of electrical energy. By repeating the movement of the charged barrier in the presence of an audible signal, the animals are trained to associate the audible signal with the movement of the barrier in a charged state and are subsequently move through the passageway ahead of the barrier even without a charge on the conductors.

Thus a portable, retractable controlling barrier for animals which may be operated by a single person, is colour sensitive to animal type and calming, and is lightweight is desirable.

### SUMMARY OF THE INVENTION

An object of one aspect of the present invention is to provide an improved portable, retractable controlling barrier for animals.

In accordance with one aspect of the present invention there is provided a portable retractable controlling barrier for animals including a biased retractable support assembly and an animal sensitive barrier member releasably mounted to the biased retractable support assembly allowing for the extension of the animal sensitive barrier member and then the automatic and biased retraction of the animal sensitive barrier member.

Conveniently, the biased retractable support assembly includes a frame having a first end with a first support means adapted to receive a first end of a biasing mechanism. The frame has a second end with a second support means to receive a second end of the biasing mechanism.

Preferably, the biasing mechanism includes an internal housing positioned between the first and second support means and adapted to receive a rod which is positioned between and mounted to the first and second ends of the frame. The biasing mechanism further includes a biasing means adapted to engage the first support means and the second support means via an external housing to which the biasing means engages.

Conveniently the animal sensitive barrier may be colour so as to be sensitive to the species or gender of the animal being controlled. Specifically market hogs respond to the colour red and as such are easier to control when the animal sensitive barrier is made from an opaque red material.

Advantages of the present invention are: time saving device for controlling and herding animals, cost efficient as it only requires one person to operate the device, portable and light weight so it can be taken anywhere, easy to mount on to any structure therefore does not require any alteration to existing structures, effective with different species and genders of animals as the barrier is colour sensitive to the animal being herded, is retractable, does not require other aids to move the animals, weather resistant, made from sanitary material, non-invasive, non-abusive and less stress to animals, reduced stress and anger on the user moving the animals, continuous, equal tension on the barrier member through the entire extension of the barrier member from the biased retractable support assembly, carrying handle may also act as a hinge attachment, and the barrier member is easily replaceable if damaged.

### BRIEF DESCRIPTION OF THE DRAWINGS

A detailed description of the preferred embodiments is provided herein below by way of example only and with reference to the following drawings, in which:

FIG. 1 in a perspective view, illustrates a portable, retractable, controlling barrier for animals in the retracted position in accordance with the preferred embodiment of the present invention;

FIG. 2 in a perspective view, illustrates the controlling barrier of FIG. 1 in a partial extended position.

FIG. 3a in a perspective view, illustrates the animal sensitive barrier member of the controlling barrier of FIG. 1 indicating a first colour.

FIG. 3b in a perspective view, illustrates the animal sensitive barrier member of the controlling barrier of FIG. 1 indicating a second colour.

FIG. 4 in perspective view, illustrates the controlling barrier of FIG. 1 mounted on to a structure and in partial extension.

FIG. 5 in a top plan view, illustrates the controlling barrier of FIG. 4.

FIGS. 6a and 6b in top plan views illustrate the controlling barrier of FIG. 1 in use.

FIG. 7a in a top plan view illustrates the controlling barrier of FIG. 1 in use segregating one animal.

FIG. 7b in a top plan view illustrates the controlling barrier of FIG. 1 in use segregating multiple animals.

FIG. 8 in a cross-sectional view along the line 5-5 illustrates the retracting member in the controlling barrier of FIG. 1.

FIG. 9 in an exploded view, illustrates the retracting member of FIG. 8.

FIG. 10 in a top plan view, illustrates the controlling barrier of FIG. 1 in use in a transport vehicle.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

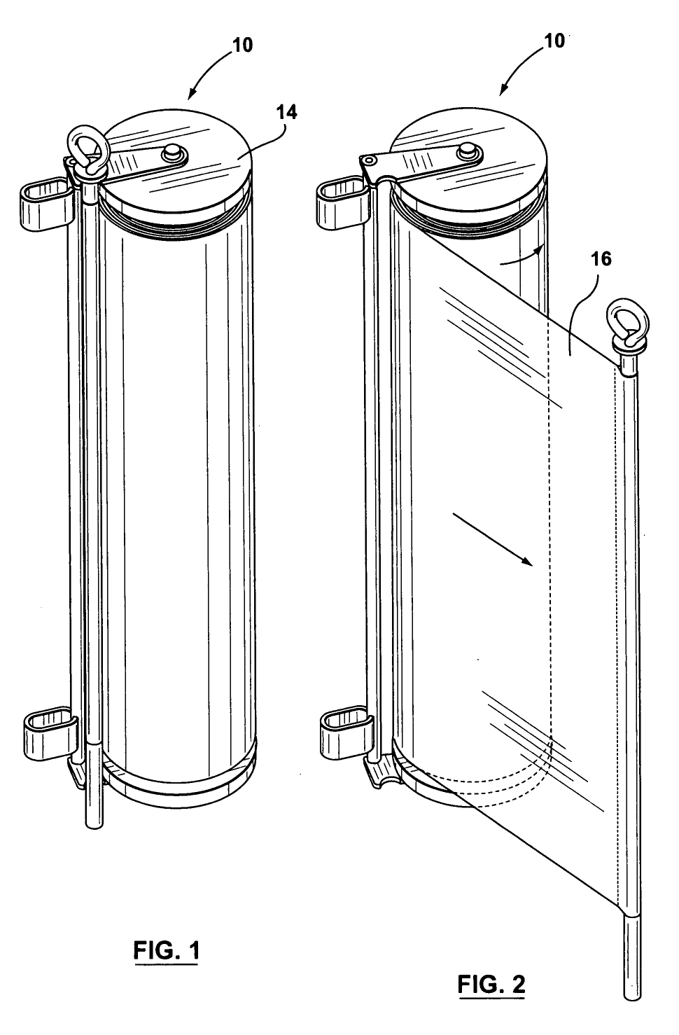

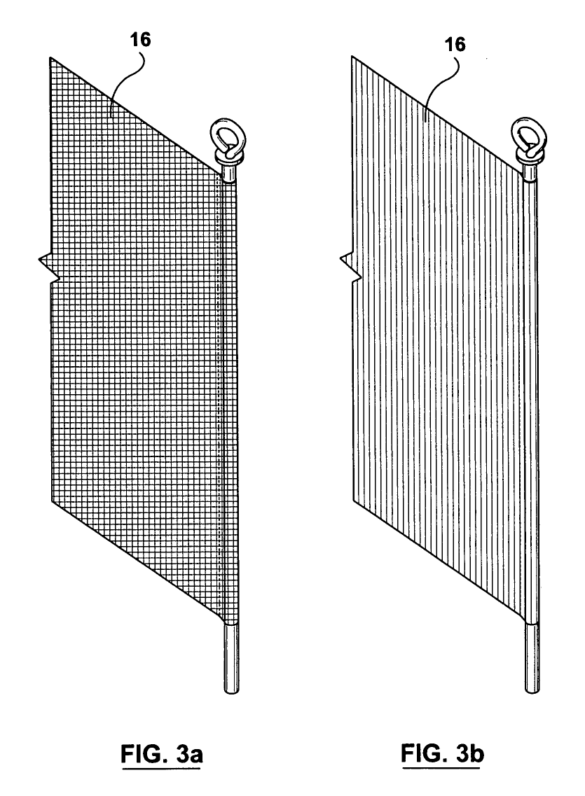

Referring to FIGS. 1 and 2, there is illustrated in perspective views, a portable retractable controlling barrier 10 for animals 12 in accordance with a preferred embodiment of the present invention. The portable retractable controlling barrier 10 for animals 12 includes a biased retractable support assembly 14 and an animal sensitive barrier member 16 releasably mounted to the biased retractable support assembly 14 wherein the animal sensitive barrier member 16 is extendible and retractable. The portable tractable controlling barrier 10 therefore is biased to the retracted position and therefore extends under tension to the desired length and then is biased back towards the retracted position.

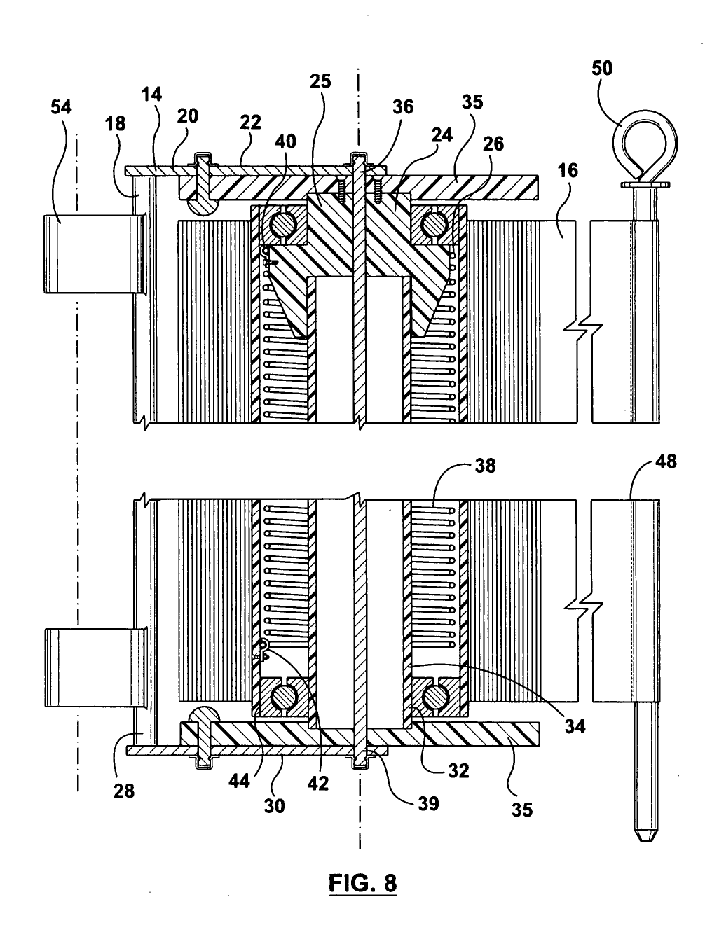

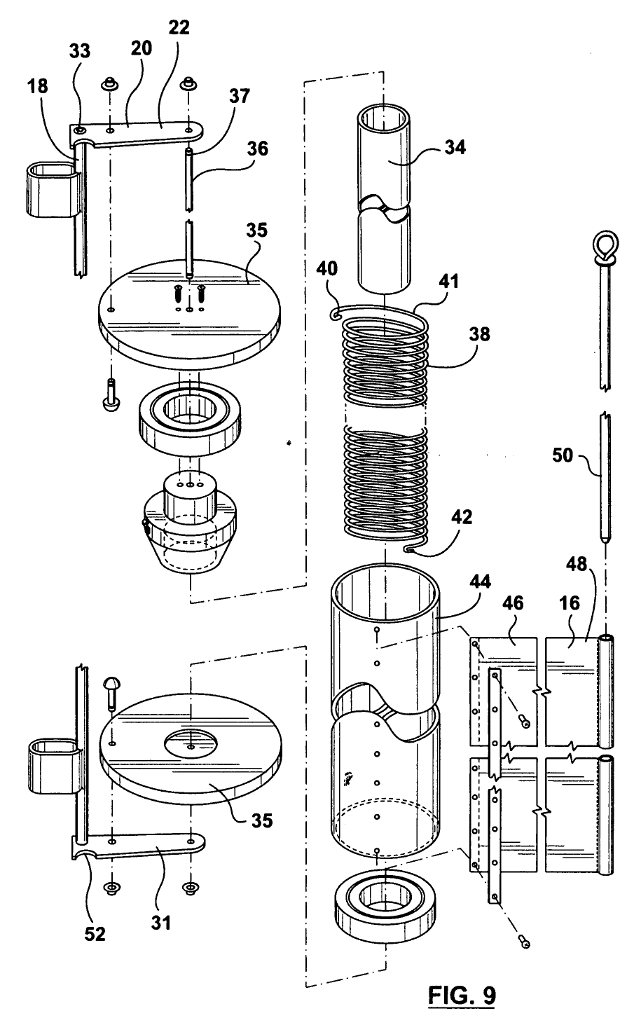

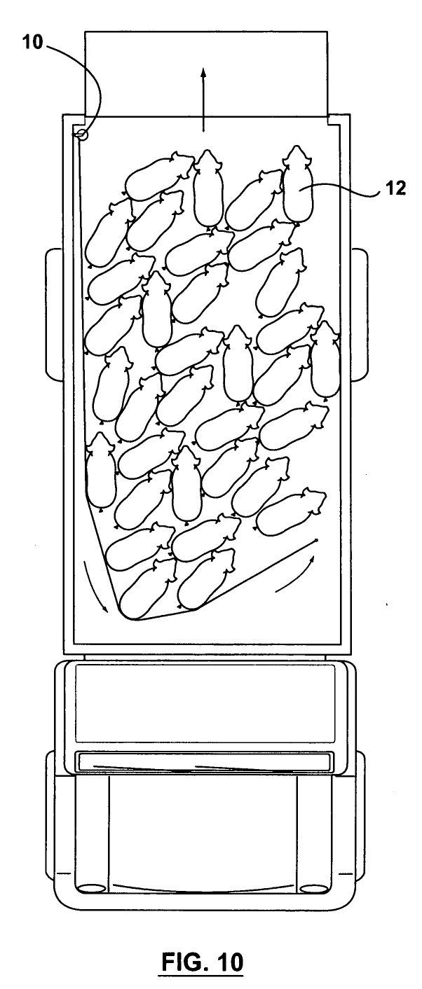

Referring to FIGS. 8 and 9, the biased retractable support assembly 14 further includes a frame 18 having a first end 20 having a first support means 22 to receive a first end 24 of a biasing mechanism 26. A second end 28 of the frame 18 further includes a second support means 30 to receive a second end 32 of the biasing mechanism 26.

The biasing mechanism 26 includes an internal housing 34 positioned between the first and second supports means 22 and 30, so as to engage the first and second ends 20 and 28 of the frame 18. More specifically the first end 24 of the biasing mechanism 26 may further include a positioning member 25 that is adapted to receive a first end of the internal housing 34. The positioning member 25 may be mounted to the first support means 22. More specifically the internal housing 34 may be a hollow tubular structure.

Furthermore the internal housing 34 is adapted to receive a rod 36 so that the rod 36 is positioned between and mounted to the first end 20 and the second end 28 of the frame 18. The rod 36 therefore is secured into the first and second support means 22 and 28 respectively. The first and second support means 22 and 28 may include support arms 31 hingedly secured to the frame 18 by a pin 33 or similar attachment mechanism. The first and second support means 22 and 28 may also include end plates 35 secured to the support arms and which are adapted to receive a first and second end 37 and 39 respectively of the rod 36.

The biasing mechanism 26 is further includes as a biasing means 38 having a first end 40 adapted to engage the positioning member 25 and a second end 42. The biasing means 38 may be furthered define a coiled spring 41. The biasing means 38 provides constant tension on the animal sensitive barrier 16. Therefore even in the retracted position the biasing means 38 provides tension on the animal sensitive barrier 16.

An external housing 44 encases the biasing means 38, the internal housing 34 and the rod 36. The second end 42 of the biasing means 38 is adapted to engage the external housing 44. Furthermore the external housing 44 allows for the releasable engagement of a first end 46 of the animal sensitive barrier member 16. The external housing 44 allows for the animal sensitive barrier member 16 to be wrapped around the external housing 44 when in the retracted position.

The animal sensitive barrier member 16 may be further defined as a flexible, opaque fabric barrier 50 that has a first end 46 and a second end 48 that is washable. The fabric may be removed from the external housing 44 when the flexible fabric barrier 50 requires washing or a different colour of flexible fabric barrier 50 is desired. Specifically the flexible fabric barrier 50 may be changed so that the colour of the flexible fabric barrier 50 is sensitive to the animal being controlled or moved. The sensitivity may be chosen based on gender or species. For example market hogs respond to the colour red. As such, when a red, opaque flexible fabric barrier is utilized, the pigs respond in a more calm manner during the movement of the pigs from one point to another. Breeding sows or gilts however respond well to the colour blue, so a blue flexible fabric barrier 50 works better for that gender. Other colours may be used depending on the animal being moved.

Furthermore the flexible fabric barrier 50 can withstand washing up to 3000 psi, and is made from sanitary material that meets quality assurance standards and bio-security standards. Furthermore the flexible fabric barrier 50 is resistant to weather elements such as extreme cold, rain, and snow and elements that arise from various situations specific to use such as exposure to ammonia. The flexible fabric barrier 50 easily rolls onto the external housing 44 and can function with the biased retractable support assembly 14 up to sixty feet in length. The flexible fabric barrier 50 is also very lightweight, for example 3.63 ounces per linier yard which contributes to the overall lightweight feature of the portable, retractable controlling barrier 10.

The animal sensitive barrier member 16 may have a second end 48 adapted to engage a pull rod 50. The pull rod 50 engages the length of the animal sensitive barrier 16 therefore providing tension on the animal sensitive barrier member 16 equally from the top to the bottom of the animal sensitive barrier member 16. As noted above the animal sensitive barrier member 16 is constantly under tension. The pull rod 50 helps is maintaining that tension when the animal sensitive barrier member 16 is being extended. When in the retracted position, the pull rod 50 can rest against a stop 52 located on the frame 18. Even when resting against the stop 52 the pull rod 50 and the animal sensitive barrier 16 are under tension.

The first and second ends of the frame 20 and 28 respectively are hingedly mounted to the frame 18. Furthermore the frame 18 may act as a handle to easily carry the retractable controlling barrier 10 therefore making it portable. The frame 18 may be made from a light weight material such as aluminium by way of example only which contributes in the portability of the portable retracting controlling barrier 10. Furthermore the frame 18 may be rust resistant so that it can be used outside in various types of weather. The frame 18 may also include attachment loops 54 that are adapted to receive a securing member such as a drop rod 56 to securely attach the portable retractable controlling barrier 10 to a structure such as a barn wall, or transport vehicle by way of example only. As the portable retractable controlling barrier 10 is easy to move and mount on various structures, there is no need to adapt or change existing structures to accommodate the portable retractable controlling barrier 10.

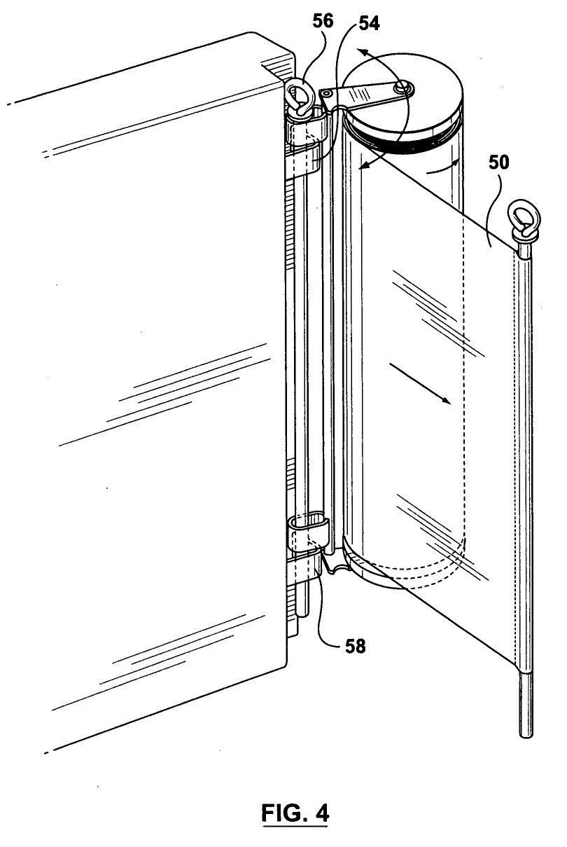

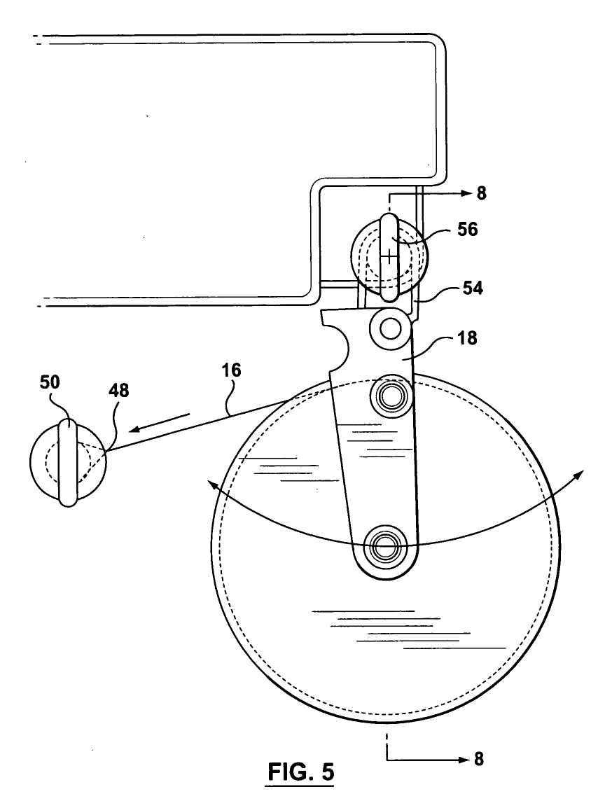

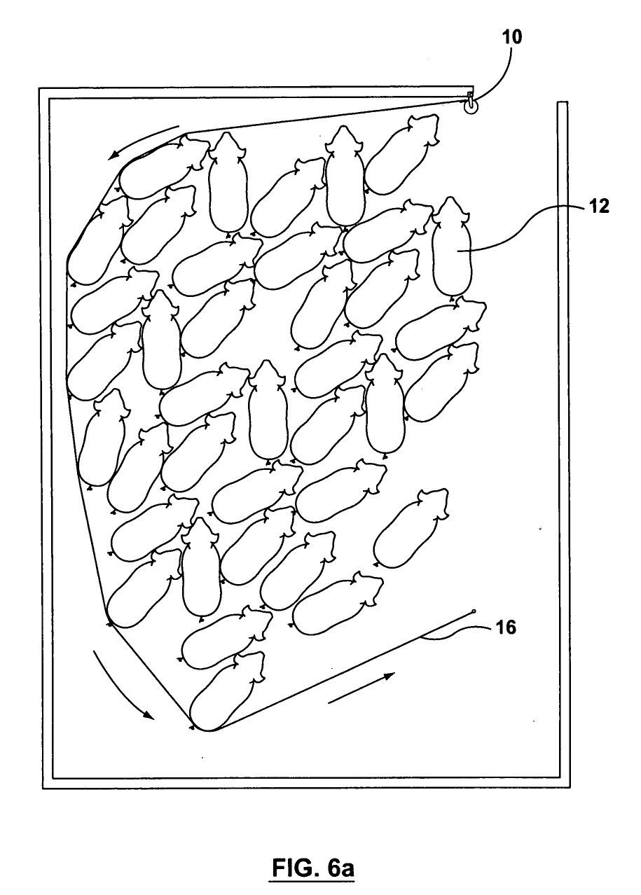

In operation, the portable retractable controlling barrier 10 may be mounted to a structure and extended to selectively control and move animals. How this is achieved is explained here below with reference to FIGS. 4, 5, 6a, 6b, 7a, 7b and 10. The portable retractable controlling barrier 10 requires a single person to mount the portable retractable controlling barrier 10 to structure such as a barn wall or transport vehicle wall. This is achieved by positioning the portable retractable controlling barrier 10 so that attachment loops 54 lines up with corresponding loops 58 on the structure or the attachment loops 54 may be used to mount the portable retractable controlling barrier 10 in some other fashion to a support structure. The drop rod 56 then is slid through both the attachment loops 54 and the corresponding loops 58 so as to securely attach the portable retractable controlling barrier 10 to the structure. The portable retractable controlling barrier 10 is now ready to be extended. The user may grasp the pull rod 50 and walk towards the animals. As the user walks with the pull rod, the animal sensitive barrier 16 extends under tension. As the portable retractable controlling barrier 10 is lightweight the user can easily pull and extend the animal sensitive barrier 16 as they walk into the enclosure and corral the desired number of animals. The user may tap the pull rod 50 against the ground and giggle the animal sensitive barrier 16 as they corral the animals to further aid the corralling process.

The use of a colour sensitive barrier for a particular animal being herded results in a more calm process as the animal responds well to the particular colour and moves away from the barrier. Therefore the animal may be corralled or moved more efficiently and more calmly as the animals are more organized and are not panicking in flight in all different directions. As the animal sensitive barrier 16 is easily positioned by the user, the user can quietly walk throughout the enclosure and corral the desired animals, while keeping the barrier between him/herself and the animals. Therefore the animals respond and move against and away from the animal sensitive barrier 16 which keeps them calm and quiet due to the appropriate colour being used.

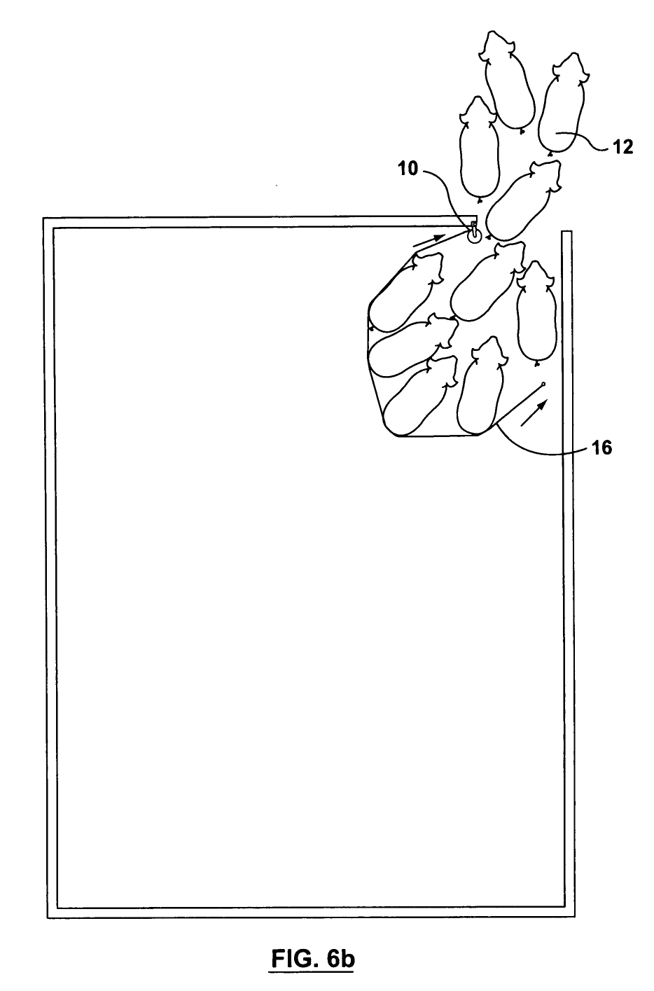

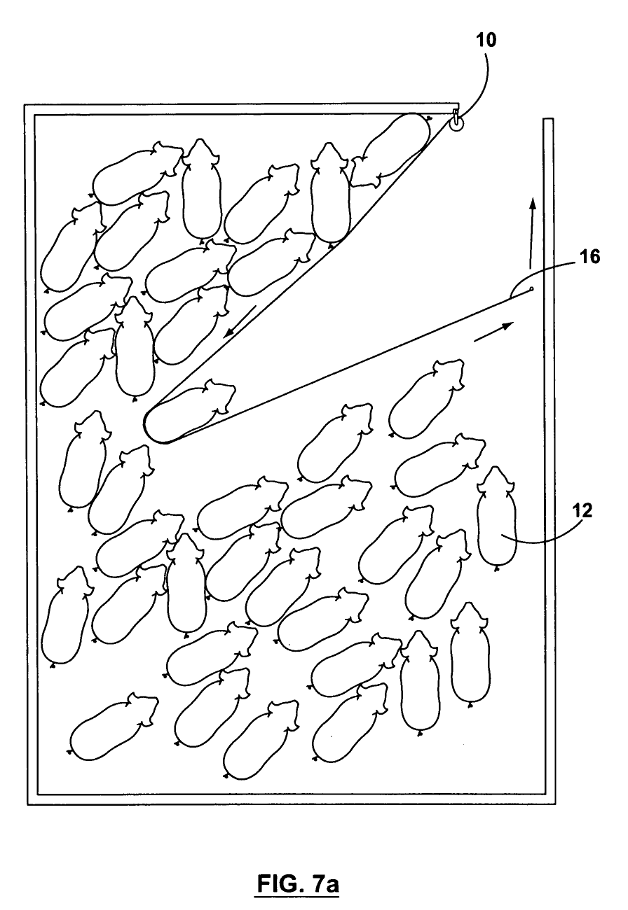

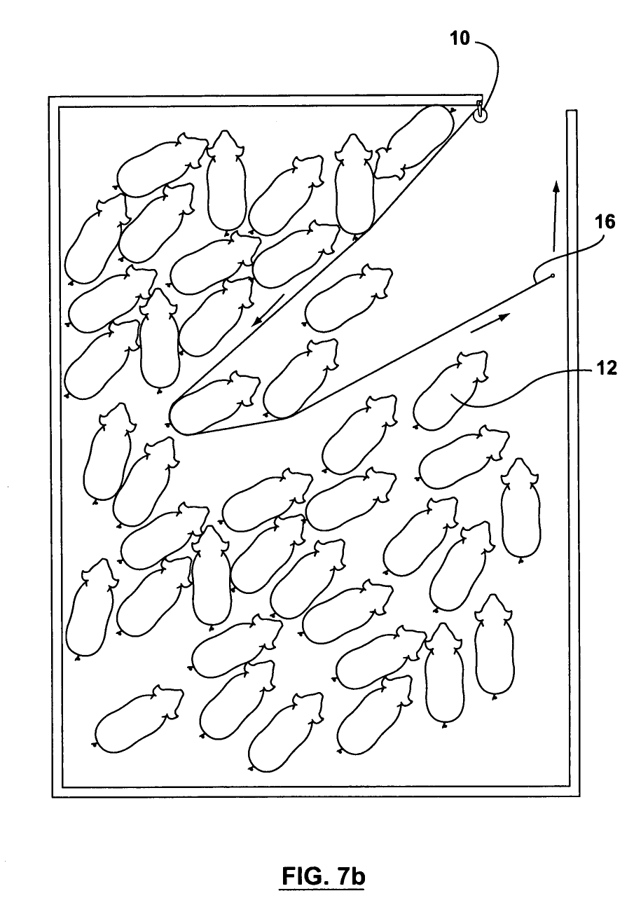

FIGS. 6a and 6b illustrate the corralling and movement of an entire pen of animals with just a single person operating the portable retractable controlling barrier 10. FIG. 7a shows the corralling of a single animal from the other animals, and FIG. 7b illustrates the corralling a few animals at one time while leaving the majority of the animals in the enclosure. Finally FIG. 10 shows the portable retractable controlling barrier 10 mounted to a transport vehicle and the movement of the animals out of the vehicle.

The utilization of the portable retractable controlling barrier 10 not only requires a single user but does not require any other accessories such as a chase stick to move the animals. Furthermore the use of the portable retractable controlling barrier 10 is non-invasive and non abusive to the animals being controlled and meets the current standards for the humane treatment of animals. The use of the barrier also helps to reduce the stress on the animal during the normally stressful transfer of animals. It also reduces the stress on the user as the action of moving and corralling the animals is handled more quickly and with less error. Finally the use of the portable retractable controlling barrier saves time as it quickly limits the direction that the animal may move in allowing for efficient corralling of the animals by a single user.

Other variations and modifications of the invention are possible. All such modifications or variations are believed to be within the sphere and scope of the invention as defined by the claims appended hereto.

We claim:

1. A portable retractable controlling barrier for animals, comprising:
(a) a biased retractable support assembly, and
(b) an animal sensitive barrier member releasably mounted to the biased retractable support assembly,
wherein the animal sensitive barrier member is extendible and retractable.

2. A portable retractable controlling barrier for animals as claimed in claim 1 wherein the biased retractable support assembly further comprises a frame having a first end having a first support means adapted to receive a first end of a biasing mechanism and a second end having a second support means adapted to receive a second end of the biasing mechanism.

3. A portable retractable controlling barrier for animals as claimed in claim 2 wherein the biasing mechanism further comprises an internal housing positioned between the first and second support means and adapted to receive a rod, wherein the rod extends between the first end and the second end of the frame and mounts into the first and second support means respectively.

4. A portable retractable controlling barrier for animals as claimed in claim 3 wherein the first end of the biasing mechanism further includes a positioning member adapted to receive a first end of the internal housing and the rod and is mounted to the first support means.

5. A portable retractable controlling barrier for animals as claimed in claim 3 wherein the internal housing is a hollow tubular structure.

6. A portable retractable controlling barrier for animals as claimed in claim 2 wherein the first and second support means are support arms that hingedly engage the frame.

7. A portable retractable controlling barrier for animals as claimed in claim 4 wherein the biasing mechanism further comprises a biasing means having a first end adapted to engage the positioning member, and a second end adapted to engage the internal housing.

8. A portable retractable controlling barrier for animals as claimed in claim 7 wherein the biasing means is a coiled spring.

9. A portable retractable controlling barrier for animals as claimed in claim 7 wherein the portable retractable controlling barrier further comprises an external housing that encases the biasing means, the internal housing and the rod.

10. A portable retractable controlling barrier for animals as claimed in claim 9 wherein the external housing is adapted to releasably engage a first end of the animal sensitive barrier.

11. A portable retractable controlling barrier for animals as claimed in claim 3 wherein the animal sensitive barrier is a flexible, opaque fabric barrier.

12. A portable retractable controlling barrier for animals as claimed in claim 11 is wherein the colour of the flexible fabric barrier is chosen according to the animal being controlled.

13. A portable retractable controlling barrier for animals as claimed in claim 12 wherein the flexible fabric barrier is washable and able to withstand washing up to 3000 psi.

14. A portable retractable controlling barrier for animals as claimed in claim 12 wherein the flexible fabric barrier is weather resistant and light weight.

15. A portable retractable controlling barrier for animals as claimed in claim 11 wherein the animal sensitive barrier has a second end adapted to engage a pull rod providing equal tension against the animal sensitive barrier in the extended position.

16. A portable retractable controlling barrier for animals as claimed in claim 15 wherein the frame further includes a stop against which the pull rod may rest against when in a retracted position.

17. A portable retractable controlling barrier for animals as claimed in claim 2 wherein the frame is made from aluminium.

18. A portable retractable controlling barrier for animals as claimed in claim 2 wherein the frame may further include at least one attachment means adapted to receive a securing member.

19. A portable retractable controlling barrier for animals as claimed in claim 18 wherein the securing member is a drop rod.

20. A portable retractable controlling barrier for animals as claimed in claim 18 wherein the attachment means are attachment loops.
